(19) United States
(12) Patent Application Publication
(10) Pub. No.: US 2008/0169910 A1
(43) Pub. Date: Jul. 17, 2008

(54) Implementation of a wireless power transmitter and method

(75) Inventors: Charles E. Greene, Cabot, PA (US); Daniel W. Harrist, Carnegie, PA (US); Michael Thomas McElhinny, Port Vue, PA (US)

Correspondence Address: Ansel M. Schwartz;Attorney at Law, Suite 304, 201 N. Craig Street, Pittsburgh, PA, 15213, US

(73) Assignee: Powercast Corporation

(21) Appl. No.: 12/005,737

(22) Filed: Dec. 28, 2007

Related U.S. Application Data
(60) Provisional application No. 60/878,897, filed on Jan. 5, 2007.

(51) Int. Cl. H04Q 5/22

(52) U.S. Cl. 340/10.34

(57) ABSTRACT

Disclosed is a device for a particular purpose. The device includes a housing. A wireless power transmitter is connected to the housing. The wireless power transmitter sends wireless power. The particular purpose is something other than sending wireless power. A method for a particular purpose.

### FIELD OF THE INVENTION

The present invention is related to the implementation of a wireless power transmitter. More specifically, the present invention is related to the wireless powering of target devices within the peripheral of a wireless power transmitter implemented in conjunction with a source device, apparatus, or structure (collectively “devices”).

### BACKGROUND OF THE INVENTION

As processor capabilities have expanded and power requirements have decreased there has been an ongoing explosion of devices that operate completely independent of wires or power cords. These “untethered” devices range from cell phones and wireless keyboards to building sensors and active RFID tags. Engineers and designers of these untethered devices continue to have to deal with the limitations of portable power sources, primarily batteries as the key design parameter. While performance of processors and portable devices has been doubling every 18-24 months driven by Moore's law, battery technology in terms of capacity has only been growing at measly 6% per year. Even with power conscious designs and the latest in battery technology, many devices do not provide the lifetime cost and maintenance requirements for applications that require a large number of untethered devices such as logistics and building automation. Today's devices that need two-way communication require scheduled maintenance every three to 18 months to replace or recharge the device's power source (typically a battery). One-way devices simply broadcasting their status (one-way) such as automated utility meter readers have a better battery life, typically requiring replacement within 10 years. For both device types, scheduled power-source maintenance is costly and disruptive to the entire system that a device is intended to monitor and/or control. Unscheduled maintenance trips are even more costly and disruptive. On a macro level, the relatively high cost associated with the internal battery also reduces the practical, or economically viable, number of devices that can be deployed.

The ideal solution to the power problem for untethered devices is a device or system that can collect and harness sufficient energy from the external environment. The harnessed energy would then either directly power an untethered device or augment a battery or other storage component. Directly powering an untethered device enables the device to be constructed without the need for a battery. Augmenting a storage component could be along two lines: 1) increasing the overall life of the device or 2) by providing more power to the device to increase the functionality of the device. The other parameters for an ideal solution is that the harnessing device could be used in a wide range of environments including harsh and sealed environments (e.g. nuclear reactors), would be inexpensive to produce, would be safe for humans, and would have a minimal effect on the basic size, weight and other physical characteristics of the untethered device.

### BRIEF SUMMARY OF THE INVENTION

This invention pertains to a technique that uses radio frequency (RF) energy as a source of energy to directly power or augment a power storage component in an untethered target device. The present invention meets the requirements described in the previous “Background of the Invention” section.

The present invention pertains to a device for a particular purpose. The device comprises a housing. The device comprises a wireless power transmitter connected to the housing, wherein the wireless power transmitter sends wireless power, and the particular purpose is not sending wireless power.

The present invention pertains to a structure for a particular purpose. The structure comprises a housing. The structure comprises a wireless power transmitter connected to the housing, wherein the wireless power transmitter sends wireless power, and the particular purpose is not sending wireless power.

The present invention pertains to a device for a particular purpose. The device comprises a core device including a core device housing. The device comprises a wireless power transmitter connected to the core device housing for sending wireless power from the device, wherein the particular purpose is not sending wireless power.

The present invention pertains to a method for a particular purpose. The method comprises the steps of sending wireless power from a wireless transmitter connected to a housing. There is the step of performing a particular purpose which is not sending wireless power.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1a is a block diagram of a wireless power transmitter and antenna integrated into a core device housing along with core device components of the present invention.

FIG. 1b is a block diagram of a wireless power transmitter integrated into the same housing as the core device components.

FIG. 1c is a block diagram of a wireless power transmitter external to the core device housing.

FIG. 1d is a block diagram of a wireless power transmitter with an antenna disposed inside a structure.

FIG. 1e is a block diagram of a wireless power transmitter disposed in a structure with an antenna outside the structure.

FIG. 1f is a block diagram of a wireless power transmitter with an antenna disposed external to the structure.

FIG. 1g is a block diagram of a wireless power transmitter and core device components disposed internal to the housing, with shielding disposed about the core device components.

FIG. 2a is a block diagram of a wireless power transmitter having a frequency generator and amplifier.

FIG. 2b is a block diagram of a wireless power transmitter having a frequency generator, amplifier, filter, controller, power sensor and bidirectional coupler.

FIG. 3a is a block diagram of a housing having a wireless power transmitter and core device components internal to the housing.

FIG. 3b is a block diagram of core device components having a frequency generator and a power splitter.

FIG. 4a is a block diagram of a housing having a wireless power transmitter and core device components disposed internal to the housing.

FIG. 4b is a block diagram of core device components having a combining device, amplifier and separating device.

FIG. 4c is a block diagram of core device components having a switch, amplifier and another switch.

FIG. 5 is a block diagram of a housing having a wireless power transmitter and core device components.

FIG. 6 is a block diagram of a lamp base having a lamp socket with a bulb with an AC/DC converter and wireless power transmitter.

### DETAILED DESCRIPTION OF THE INVENTION

A complete understanding of the invention will be obtained from the following description when taken in connection with the accompanying drawing figures wherein like reference characters identify like parts throughout.

The present invention pertains to a device 10 for a particular purpose. The device 10 comprises a housing 12. The device 10 comprises a wireless power transmitter 14 connected to the housing 12, wherein the wireless power transmitter 14 sends wireless power, and the particular purpose is not sending wireless power.

The wireless power transmitter 14 can be either inside or outside the housing 12. The device 10 can further include an antenna 16 connected to the wireless power transmitter 14. The antenna 16 can be inside or outside the housing 12. The transmitter 14 can send wireless power in pulses.

The device 10 can further including core device components 18 inside the housing 12. The wireless power transmitter 14 can share one or more of the core device components 18. The device 10 can include shielding 20.

In one embodiment, the device 10 is a lamp 22 and the housing 12 is a lamp 22 base 24. The device 10 can include a light bulb socket 26 supported by the lamp base 24. The device 10 can include wiring 28 connected to the light bulb socket 26 and to the transmitter 14 through which power is provided to them. The device 10 can include a switch 30 connected to the wiring 28 to control the flow of electricity through the wires to the transmitter 14 and to the light bulb socket 26. The switch 30 can include a microprocessor 54.

The device 10 can include an AC/DC converter 50 in communication with the switch 30 and the transmitter 14. The device 10 can include a sensor 52 and a microprocessor 54 in communication with the transmitter 14. The device 10 can include an internal member 56 disposed in the base 24 which holds the transmitter 14.

The transmitter 14 can include a frequency generator 38 and an amplifier 42 in electrical communication with the frequency generator 38 and the antenna 16. The transmitter 14 can include a controller 56 in communication with the frequency generator 38 and the amplifier 42, a power sensor 52 in communication with the controller 56, a filter 60 in communication with the amplifier 42 and a bidirectional coupler in communication with the filter 60 and the power sensor 52 and the antenna 16.

The core device components 18 can include a frequency generator 38, and a power splitter 40 in communication with the frequency generator 38 and the transmitter 14 and other core device components 18. The core device components 18 can include an amplifier 42 in communication with the transmitter 14 and other core device 34 components 18. The core device components 18 can include a combining device 44 in communication with the transmitter 14 and the other core device components 18 and the amplifier 42, and a separating device 46 in communication with the amplifier 42 and the transmitter 14 and the other core device components 18. The combining device 44 can be a first switch 30a, and the separating device 46 is a second switch 30b.

The device 10 can include an antenna 16, and wherein the core device components 18 include a combiner 48 in communication with the transmitter 14 and other core device components 18 and an antenna 16.

The present invention pertains to a structure 32 for a particular purpose. The structure 32 comprises a housing 12. The structure 32 comprises a wireless power transmitter 14 connected to the housing 12, wherein the wireless power transmitter 14 sends wireless power, and the particular purpose is not sending wireless power.

The present invention pertains to a device 10 for a particular purpose. The device 10 comprises a core device 34 including a core device housing 12. The device 10 comprises a wireless power transmitter 14 connected to the core device housing 12 for sending wireless power from the device 10, wherein the particular purpose is not sending wireless power.

The present invention pertains to a method for a particular purpose. The method comprises the steps of sending wireless power from a wireless transmitter 14 connected to a housing 12. There is the step of performing a particular purpose which is not sending wireless power. Preferably, the performing step includes the step of emitting light from a light bulb 36 supported by a housing 12 which is a lamp base 24.

In the operation of the invention, the transmission and reception of wireless power has been shown in detail in numerous patent and patent applications listed below, all incorporated by reference herein. Specifically, U.S. patent application Ser. No. 11/447,412 described in great detail how an RF energy harvester could be incorporated into a device 10 in order to receive and convert wireless energy and function in conjunction with the core device 34 (as an example, how to implement an energy harvester into a wireless sensor 52). All of the following applications listed below are incorporated by reference herein.

U.S. Pat. No. 7,027,311

U.S. patent application Ser. No. 11/356,892

U.S. patent application Ser. No. 11/438,508

U.S. patent application Ser. No. 11/447,412

U.S. patent application Ser. No. 11/481,499

U.S. Patent Application No. 60/729,792

U.S. patent application Ser. No. 11/601,142

U.S. Patent Application No. 60/758,018

U.S. Patent Application No. 60/763,582

U.S. Patent Application No. 60/773,036

U.S. patent application Ser. No. 11/494,108

U.S. Patent Application No. 60/813,540

U.S. Patent Application No. 60/833,864

U.S. Patent Application No. 60/841,818

U.S. Patent Application No. 60/841,819

U.S. Patent Application No. 60/878,885

U.S. Patent Application No. 60/878,816

The invention described herein teaches how to implement a wireless power transmitter 14 into a source core device 34 while functioning in conjunction with source core device components 18.

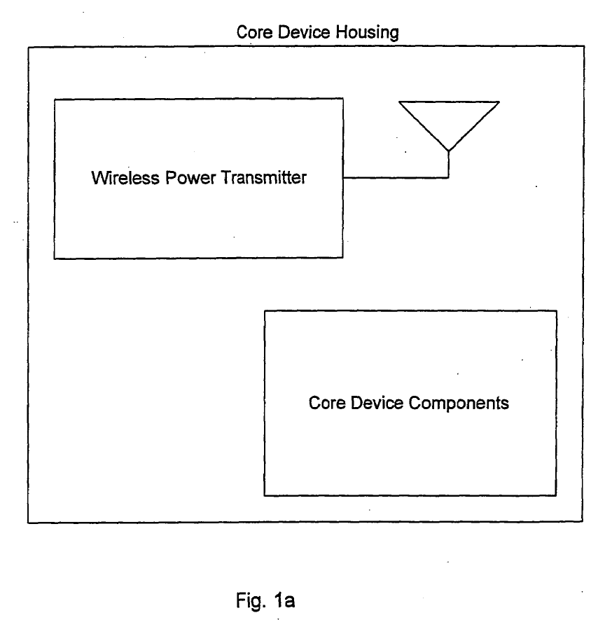

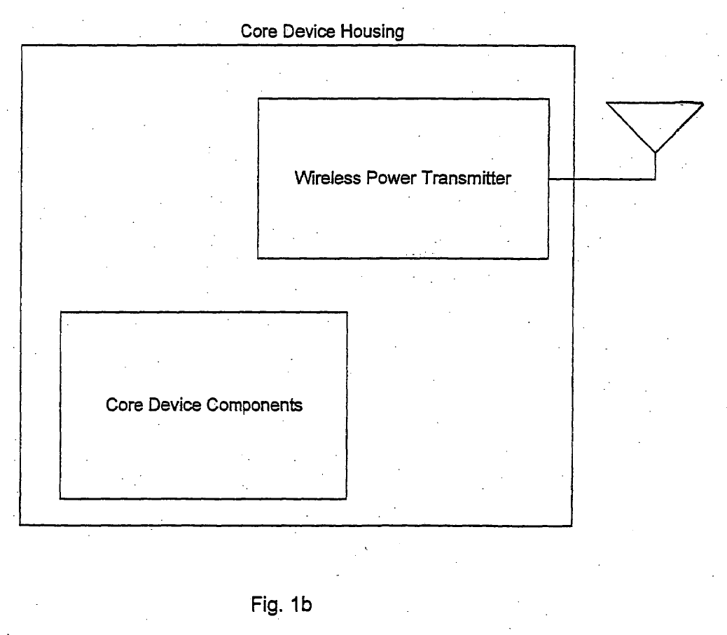

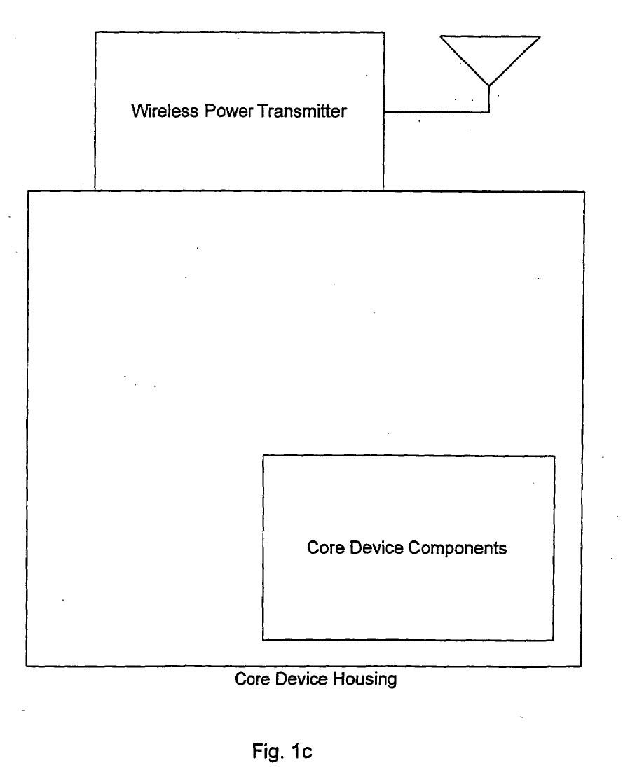

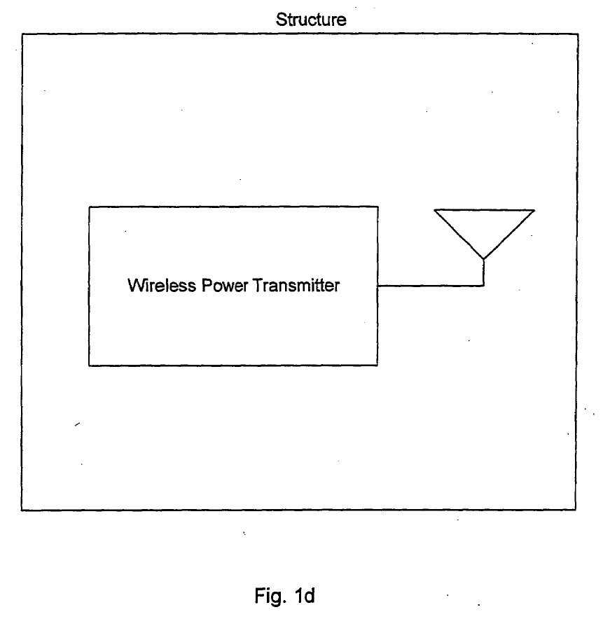

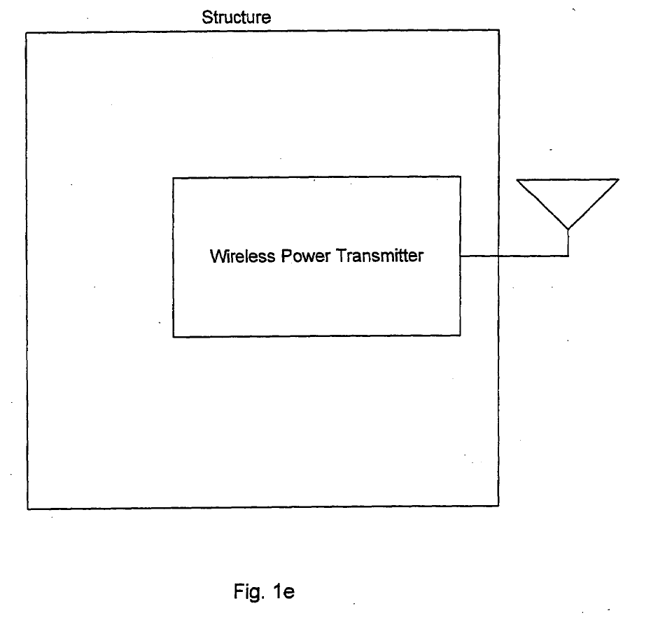

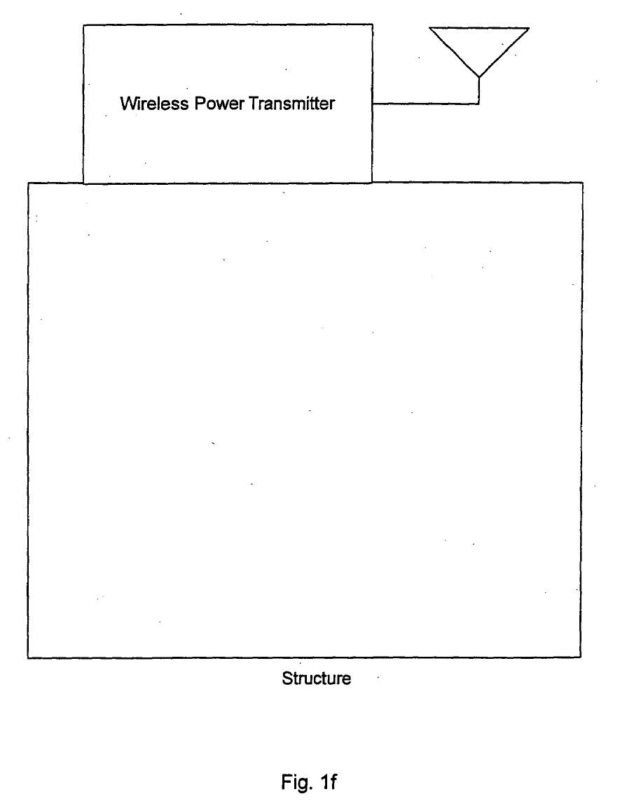

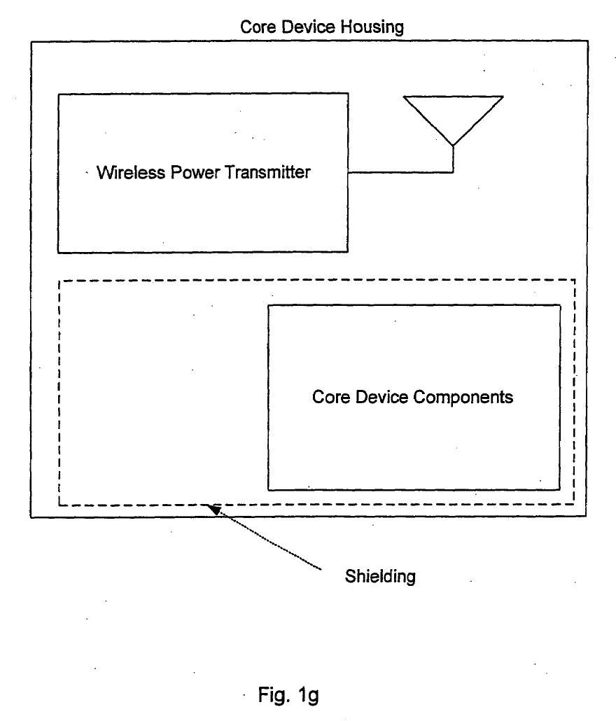

The disclosed invention is the application for transmitting radio frequency (RF) energy generated by a frequency generator 38 by use of an antenna 16 to wirelessly power target devices within the peripheral of a wireless power transmitter 14 implemented in conjunction with a source core device 34 (device, apparatus, or structure 32), where the source core device 34 has a particular purpose other than sending wireless power. (For convenience, for the remainder of this document, “core device” means “source core device”). Target devices or target core devices are labeled specifically with “target”. FIGS. 1-5 show how the system could be implemented.

The present invention can be implemented in numerous ways. Referring to FIG. 1a, the Wireless Power Transmitter 14 and antenna 16 may be integrated into a core device housing 12 along with core device components 18. The core device components 18 are the components necessary for the core device 34 to operate as intended for its primary purpose. As an example, the core device components 18 for a computer monitor would include the LCD, LCD driver, power supply, etc. The Wireless Power Transmitter 14 and/or antenna 16 may be supported by the Core device Housing 12 or by one or more of the Core Device components 18. As an example, the Wireless Power Transmitter 14 and antenna 16 may be attached to the plastic housing 12 of a device 10 or may be connected to Internal Members 56, for example, one of the internal printed circuit boards.

Referring to FIG. 1b, the Wireless Power Transmitter 14 may be integrated into the same housing 12 as the core device components 18. The antenna 16, however, may be located outside of the Core device Housing 12. This may be necessary if the Core device Housing 12 is made of a shielding 20 (metal) or attenuating (certain types of plastic) material. It may also be advantageous to locate the antenna 16 externally in order to properly orient the antenna 16 with respect to the target device or in situations where the antenna 16 is too large to fit inside the Core device Housing 12.

Referring to FIG. 1c, in certain applications it may be necessary to place the Wireless Power Transmitter 14 external to the Core device Housing 12. The antenna 16 may be located inside or outside the Core device Housing 12. The Wireless Power Transmitter 14 is externally supported by or affixed to the Core device Housing 12.

Referring to FIGS. 1d-1f, the housing 12 may not contain any Core Device components 18 and will therefore be viewed as a structure 32. The structure 32 may be non-electronic or non-mechanical such as a picture frame or planter.

Referring to FIG. 1d, the Wireless Power Transmitter 14 and antenna 16 may be integrated into the structure 32. The Wireless Power Transmitter 14 and/or antenna 16 may be supported by a Structure Housing 12 or by a Structure Member. As an example, the Wireless Power Transmitter 14 and antenna 16 may be attached to a plastic Structure Housing 12 or may be connected to one of the internal Structure Members.

Referring to FIG. 1e, the Wireless Power Transmitter 14 may be integrated into the structure 32. The antenna 16, however, may be located outside of the Structure Housing 12. This may be necessary if the Structure Housing 12 is made of a shielding 20 (metal) or attenuating (certain types of plastic) material. It may also be advantageous to locate the antenna 16 externally in order to properly orient the antenna 16 with respect to the target device or in situations where the antenna 16 is too large to fit inside the Structure Housing 12.

Referring to FIG. 1f, in certain applications it may be necessary to place the Wireless Power Transmitter 14 external to the Structure 32 Housing 12. The antenna 16 may be located inside or outside the Structure Housing 12. The Wireless Power Transmitter 14 is externally supported by or affixed to the Structure Housing 12.

Referring to FIG. 1g, it may be necessary in certain applications to shield the Core Device components 18 from the Wireless Power Transmitter 14 and/or the antenna 16 via shielding 20. This may be necessary to avoid electromagnetic interference between the Wireless Power Transmitter 14 and/or antenna 16 and the Core Device components 18. As an example, the Core Device components 18 may radiate a small amount of energy, which may couple onto a Wireless Power Transmitter antenna port. This energy may be radiated by the antenna 16 causing the core device 34 to fail regulatory compliance. It should be noted that shielding 20 may be added between or around any individual component or groups of components of the Wireless Power Transmitter 14, the antenna 16, and/or the Core Device components 18 if found to be advantageous.

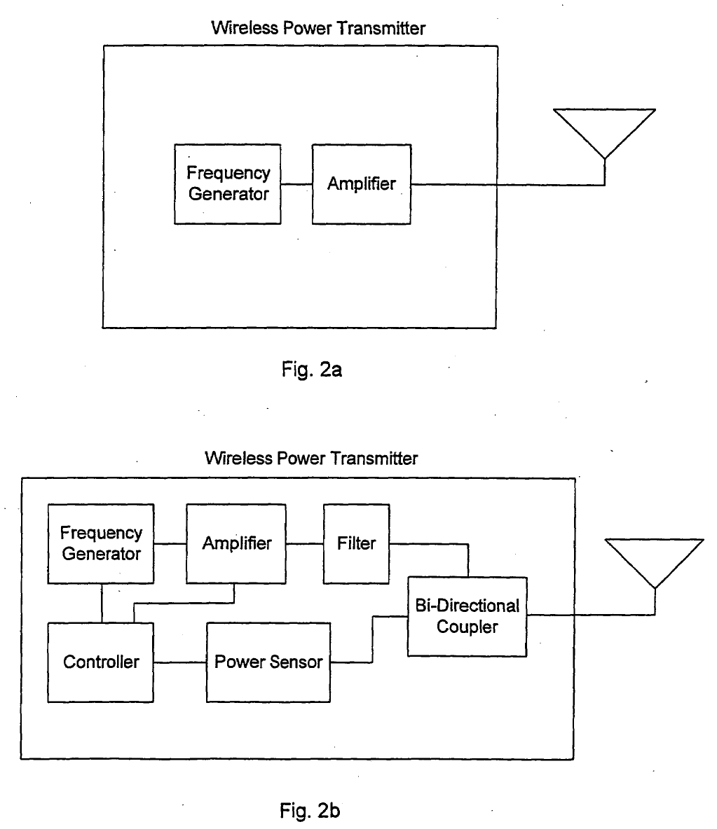

FIG. 2a shows a simple example of how to implement a Wireless Power Transmitter 14 using a frequency generator 38 and an amplifier 42 which connect to an antenna 16. The construction of such a transmitter 14 was described in detail in U.S. patent application Ser. No. 11/356,892. It may also be necessary to add additional components to the Wireless Power Transmitter 14. FIG. 2b shows a more complex Wireless Power Transmitter 14 including a feedback loop to monitor the output. This design includes a filter 60, a bi-directional coupler 58, a power sensor 52, and a controller 56. These are just two examples of how to construct a Wireless Power Transmitter 14. Numerous others exist and may be used in the invention.

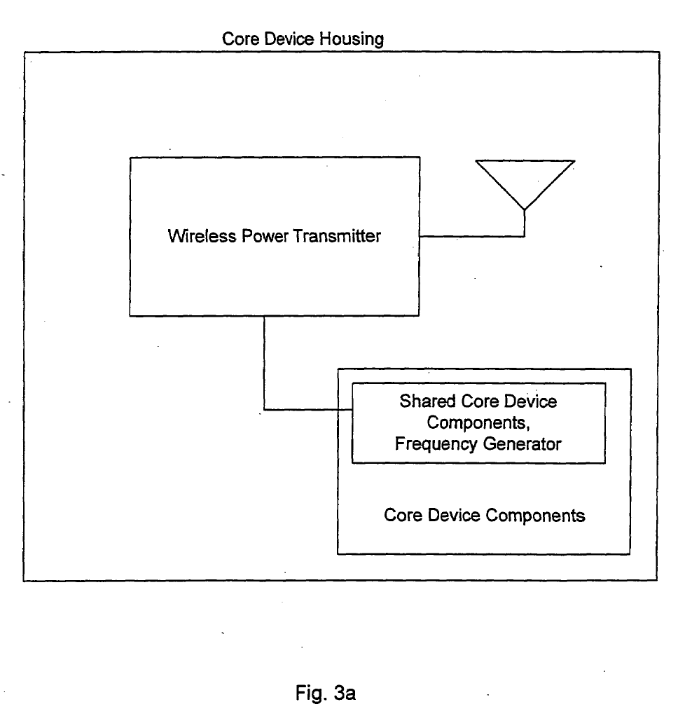

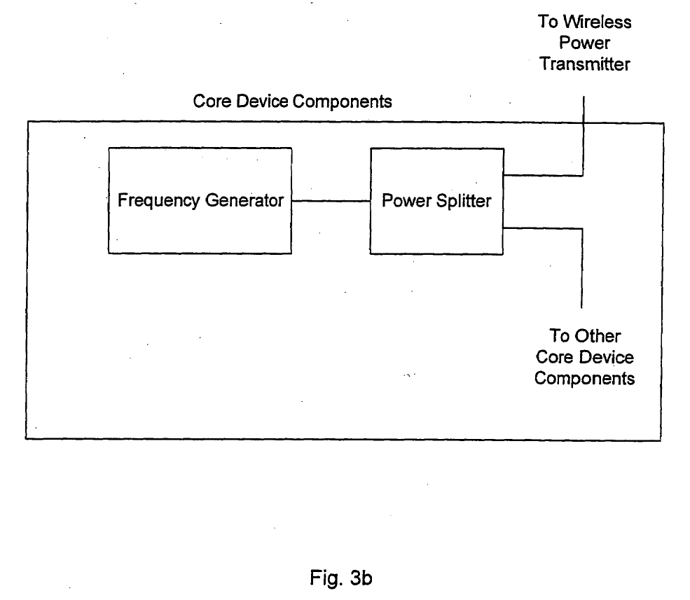

Referring to FIGS. 3-5, in certain applications it may be possible for the Wireless Power Transmitter 14 to share components with the Core device 34 and/or Core Device components 18.

FIG. 3a shows an example where the Core Device components 18 already include a Frequency Generating component. It is therefore possible for the Wireless Power Transmitter 14 to use the same Frequency Generating component as the Core Device components 18. FIG. 3b shows one example of how the Frequency generator 38 component could be shared between the Wireless Power Transmitter 14 and the Core Device components 18. The output of the Frequency generator 38 component could be connected to a Power splitter 40 that would route a portion of the power to the Wireless Power Transmitter 14 and a portion of the power to the Core Device components 18. It may also be possible for the output of the Frequency generator 38 component to be switched between the Wireless Power Transmitter 14 and the Core Device components 18. The Frequency generator 38 component could be implemented with a crystal, an oscillator, a PLL, or any other frequency generating device.

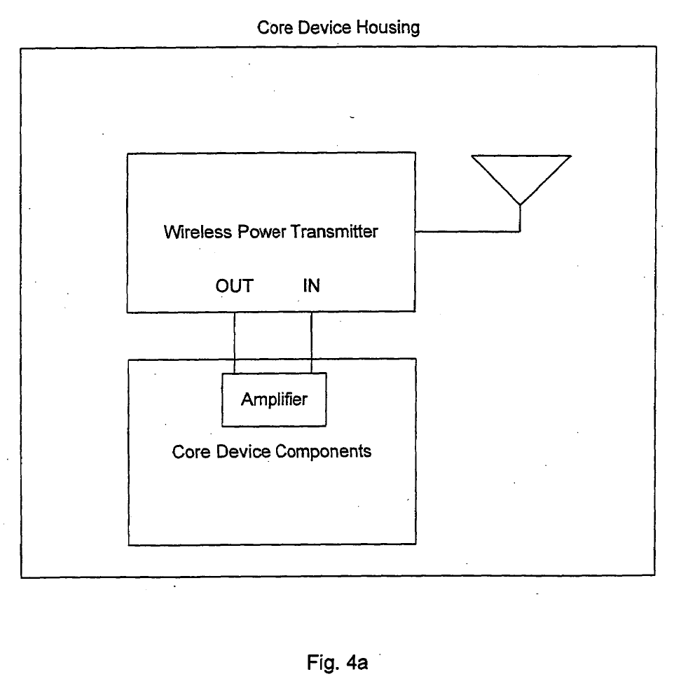

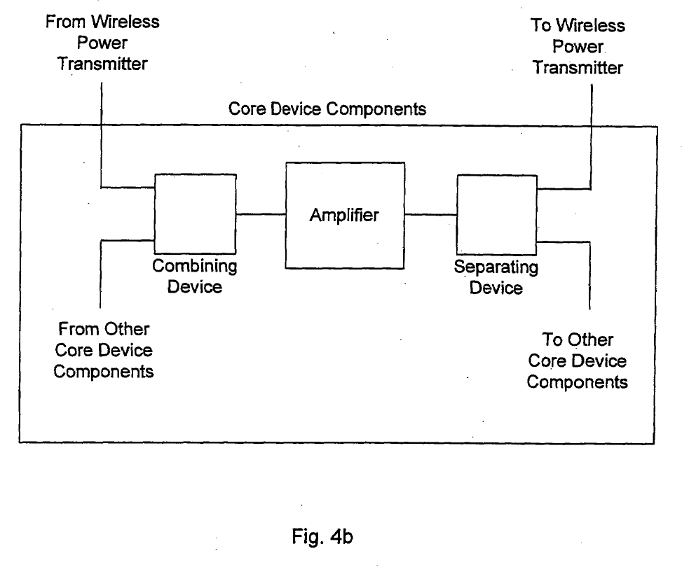

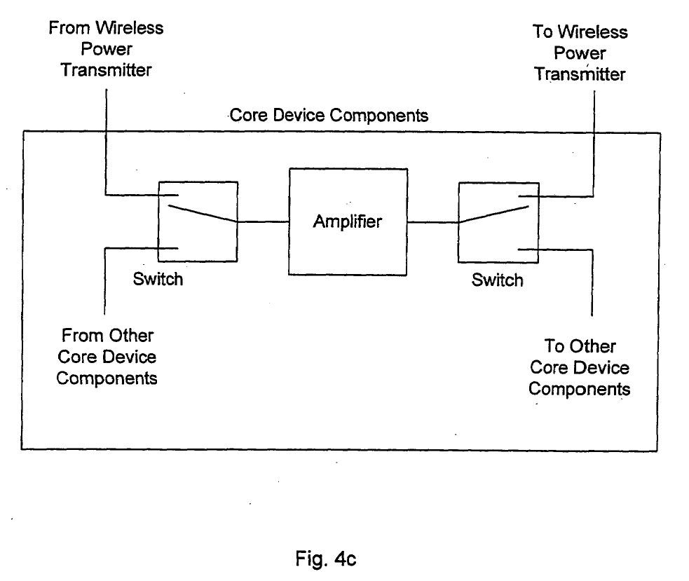

FIG. 4a shows an example where the Core Device components 18 already include an Amplifying component. It is therefore possible for the Wireless Power Transmitter 14 to use the same Amplifying component as the Core Device components 18. FIG. 4a shows one example of how an amplifier 42 could be shared between the Wireless Power Transmitter 14 and the Core Device components 18. The Wireless Power Transmitter 14 supplies an output signal to the Core device 34 Component's amplifier 42, which amplifies the signal and supplies it back to the Wireless Power Transmitter 14 through an input port. FIG. 4b and 4c show in more detail how the amplifier 42 could be shared. Specifically, in FIG. 4b, the inputs from the Core Device components 18 and the Wireless Power Transmitter 14 are combined together using a combining device 44 such as, but not limited to, a combiner 48. The combined signal is applied to the input of the amplifier 42 which gains up the signal. The output of the amplifier 42 is applied to a separating device 46 which routes the appropriate signals to the Wireless Power Transmitter 14 and Core Device components 18. The separating device 46 could be implemented with one or more bandpass filters connected to the output of the amplifier 42. FIG. 4c shows an example of how the amplifier 42 could be switched between the Wireless Power Transmitter 14 and the Core Device components 18. This solution is practical in applications where the Core Device components 18 do not utilize the amplifier 42 one hundred percent of the time. In which case, the Wireless Power Transmitter 14 could use the amplifier 42 when not required by the Core Device components 18. The resulting Wireless Power Transmitter 14 may therefore send pulses of power. This system would eliminate possible interference between the Wireless Power Transmitter 14 and communication signals transmitted by the Core Device components 18 due to the fact that wireless power is not being sent at the same time as wireless communications.

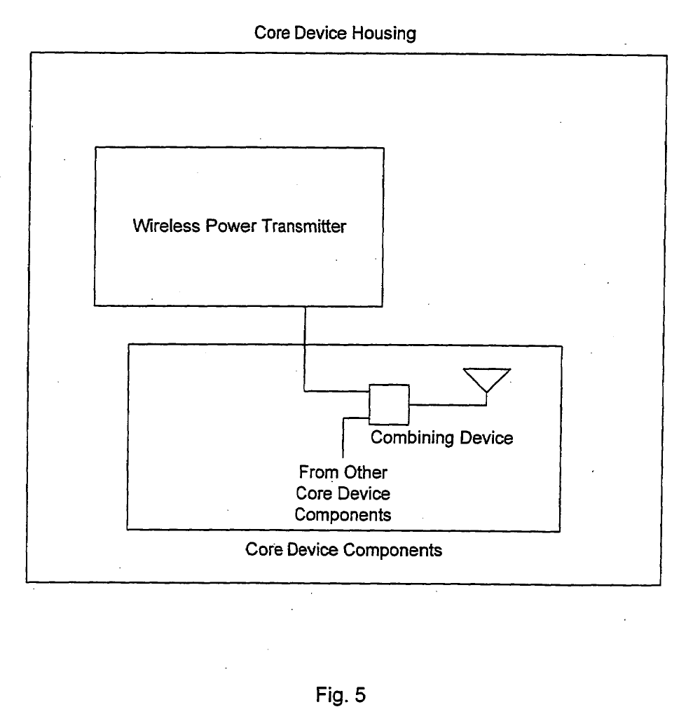

FIG. 5 shows an example where the Core Device components 18 already include an Antenna 16 component. It is therefore possible for the Wireless Power Transmitter 14 to use the same Antenna 16 component as the Core Device components 18. FIG. 5 shows one example of how an antenna 16 could be shared between the Wireless Power Transmitter 14 and the Core Device components 18. The output from the Wireless Power Transmitter 14 and the Core Device components 18 are combined together using a combining device 44 such as, but not limited to, a combiner 48. The combined signal is applied to the antenna 16 and the combined signal is radiated.

It is also possible for the Wireless Power Transmitter 14 and the Core Device components 18 to share other common components. Some other examples include, but are not limited to, a controller 56, a power supply, memory, wiring 28, a heat sink, filter 60, switch 30, power sensor 52, etc.

In certain applications, it may not be advantageous to share components between the Wireless Power Transmitter 14 and the Core Device components 18, even if they are already present in the Core Device components 18. This could be due to a reduction in performance if the components are shared.

In certain applications, it may be possible to share more than one component such as, but not limited to, an amplifier 42 and an antenna 16 between the Wireless Power Transmitter 14 and the Core Device components 18.

A Wireless Power Transmitter 14 may be used in conjunction with the following core devices 34 or structures that are for a particular purpose other than sending wireless power (these lists are not intended to be exhaustive, but as illustrative).

Devices include: Consumer electronics, electronic equipment, electrical devices, wired devices, battery powered devices, wireless communication devices, cell phones, telephones, phones, cordless phones, portable phones, Bluetooth devices, televisions, LCDs, monitors, computer monitors, computers, laptops, game consoles, chargers, charging cradles, telephone base stations, lawn ornaments, refrigerator, microwave oven, lights, lamps, light fixtures, lanterns, portable lights, flashlights, nightlights, spotlights, search lights, toys, electronics test equipment, printers, copiers, fax machines, light switches, radios, portable radios, alarm clocks, clocks, battery chargers, garage door openers, security systems, router, wireless router, wireless access point, thermostat, wireless communication dongles, dongles, computer peripherals, cars, automobiles, trucks, air purifier, heaters, space heaters, humidifiers, dehumidifiers, signs, construction signs, airplanes, boats, ships, stereos, CD players, MP3 players, music player, speakers, fans, ceiling fans, air conditioners, oven, washer, dryer, shredder, air freshener, current tap, extension cord, surge protector, uninterrupted power source (UPS), power strip, intercom, machinery, robots, automated equipment, camera, video recorders, digital picture frame, exit signs, keypads, appliances, blender, coffee maker, freezer, can opener, food processor, mixer, coffee pot, toaster, crock pot, grill, motors, generators, docking station, docking cradle, hot plates, water heater, furnace, boiler, space heater, sewing machine, ice maker, ranges, range hoods, garbage disposal, vacuum cleaner, hair dryer, traffic lights, pictures, exercise equipment, treadmills, home entertainment equipment, water fountains, water coolers, VCRs, DVD players, door bells, games, dart boards, air hockey tables, pin ball machines, arcade games, electric carts, cash registers, cable box, satellite box, electronic candles, lit structures, lit decorations, lit ornaments, pencil sharpener, power tools, battery powered tools, baby monitor, curling iron, electric razor, make-up mirror, handheld games, GPS system, riding toys, floor lamps modem, microscope, telescope, heating pads, electric beds, projector, satellite receiver, bar code receiver, answer machine, PDA, turntable, ionic cleaners, carpet cleaners, clothes iron, steamer, dry cleaner, electronic toothbrush, musical instruments, keyboard, piano, educational toys, soldering iron, hospital equipment, military equipment, weapons, etc.

Structures include: desks, Tables, Chairs, Couch, Furniture, Door, Walls, Junction Boxes, Vase, Planter, Flower Pot, Picture Frame, Pen Holder, window frames, window sills, door jams, road signs, pipes, cargo containers, shipping container, filling cabinets, white boards, book shelves, mirrors, ceiling tiles, breaker boxes, fuse boxes, Christmas trees, wreath, decorative foliage, tool boxes, toy boxes, sheds, buildings, barns, dog houses, paper towel dispensers, statues, plaques, sculpture, figurines, Head boards, beds, hospital beds, center pieces, napkin holders, spice racks, garbage cans, towers, medicine cabinets, HVAC systems, duct works, coat racks, mail boxes, telephone poles, docks, entertainment center, store shelves, shelves, elevators, escalators, automatic doors, display cases, towel rack, outlets, tree stands, etc.

To retrofit or redesign the devices listed, it is possible to implement the described systems in numerous ways. It may be advantageous to leave the device design as is and design the Wireless Power Transmitter 14 and Antenna 16 to fit into the existing Core device Housing 12 with little or no modification. It may also be advantageous to leave the device design as is and design the Wireless Power Transmitter 14 and Antenna 16 to fit into the existing Core device Housing 12 while connecting to the Core Device components 18 in order to share a component(s). As an example, the Core device 34 may remain the same; however, a wire may be connected between the Core Device components 18 and the Wireless Power Transmitter 14 in order to supply a frequency to the Wireless Power Transmitter 14. It is also possible to completely redesign the Core device 34 to include a Wireless Power Transmitter 14.

To show the flexibility of a wireless power transmission, several products were retrofitted to include a Wireless Power Transmitter 14. These products include a Christmas tree and a lamp 22.

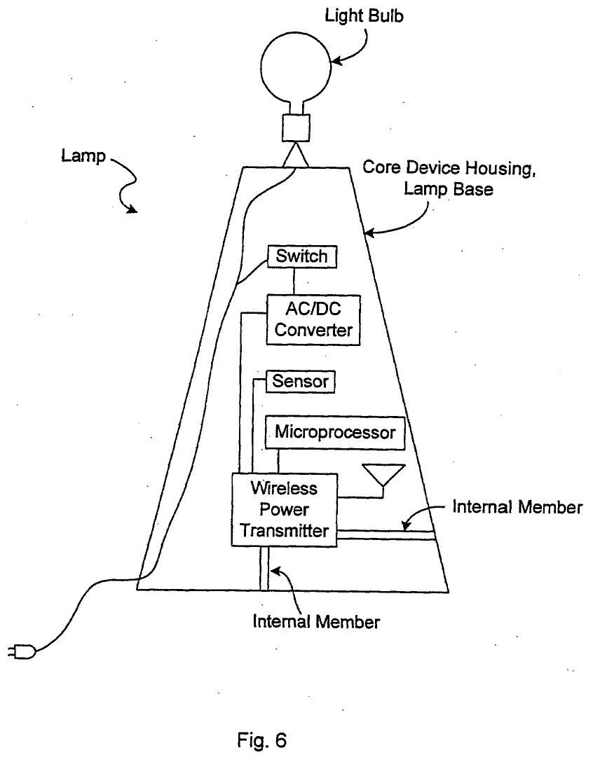

Referring to FIG. 6, the present invention was incorporated into an existing lamp 22. The Wireless Power Transmitter 14 was connected to an AC/DC converter 50, which was in turn connected to the power cord and the plug that were already included in the lamp 22. The Wireless Power Transmitter 14 was held in place within the lamp base 24 (Core device Housing 12) by Internal Members 56.

In any of the embodiments, the antenna 16 could be contained inside or placed on the outside of the device 10.

The various embodiments discussed above, and envisioned as encompassed by the present invention, may be implemented separately or in combinations with each other (in whole or in part).

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A device for a particular purpose comprising:
a housing; and
a wireless power transmitter connected to the housing, wherein the wireless power transmitter sends wireless power, and the particular purpose is not sending wireless power.

2. The device as described in claim 1 wherein the wireless power transmitter is inside the housing.

3. The device as described in claim 1 wherein the wireless power transmitter is outside the housing.

4. The device as described in claim 1 further including an antenna connected to the wireless power transmitter.

5. The device as described in claim 2 wherein the antenna is inside the housing.

6. The device as described in claim 2 wherein the antenna is outside the housing.

7. The device as described in claim 1 further including core device components inside the housing.

8. The device as described in claim 7 wherein the wireless power transmitter shares one or more of the core device components.

9. The device as described in claim 7 further including shielding.

10. The device as described in claim 1 wherein the device is a lamp.

11. The device as described in claim 10 wherein the housing is a lamp base.

12. The device as described in claim 11 including a light bulb socket supported by the lamp base.

13. The device as described in claim 12 including wiring connected to the light bulb socket and to the transmitter through which power is provided to them.

14. The device as described in claim 13 including a switch connected to the wiring to control the flow of electricity through the wiring to the transmitter and to the light bulb socket.

15. The device as described in claim 14 including an AC/DC converter in communication with the switch and the transmitter.

16. The device as described in claim 15 including a sensor and a microprocessor in communication with the transmitter.

17. The device as described in claim 16 including an internal member disposed in the base which holds the transmitter.

18. The device as described in claim 4 wherein the transmitter includes a frequency generator and an amplifier in electrical communication with the frequency generator and the antenna.

19. The device as described in claim 18 wherein the transmitter includes a controller 56 in communication with the frequency generator and the amplifier, a power sensor in communication with the controller 56, a filter in communication with the amplifier and a bidirectional coupler in communication with the filter and the power sensor and the antenna.

20. The device as described in claim 8 wherein the core device components include a frequency generator, and a power splitter in communication with the frequency generator and the transmitter and other core device components.

21. The device as described in claim 8 wherein the core device components include an amplifier in communication with the transmitter and other core device components.

22. The device as described in claim 21 wherein the core device components include a combining device in communication with the transmitter and the other core device components and the amplifier, and a separating device in communication with the amplifier and the transmitter and the other core device components.

23. The device as described in claim 22 wherein the combining device is a first switch, and the separating device is a second switch.

24. The device as described in claim 8 including an antenna, and other core device components include a combiner in communication with the transmitter and the other core device components and an antenna.

25. The device as described in claim 1 wherein the transmitter sends wireless power in pulses.

26. A structure for a particular purpose comprising:
a housing; and
a wireless power transmitter connected to the housing, wherein the wireless power transmitter sends wireless power, and the particular purpose is not sending wireless power.

27. A device for a particular purpose comprising:
a core device including a core device housing; and
a wireless power transmitter connected to the core device housing for sending wireless power from the device, wherein the particular purpose is not sending wireless power.

28. A method for a particular purpose comprising the steps of:
sending wireless power from a wireless transmitter connected to a housing; and
performing a particular purpose which is not sending wireless power.

29. A method as described in claim 28 wherein the performing step includes the step of emitting light from a light bulb supported by a housing which is a lamp base.
